(19) United States
(12) Patent Application Publication
(10) Pub. No.: US 2025/0147916 A1
(43) Pub. Date: May 8, 2025

(54) RECONFIGURABLE SERIAL INTERFACE ADDRESSING

(71) Applicant: SKYWORKS SOLUTIONS, INC., Irvine, CA (US)

(72) Inventors: Thomas Obkircher, Santa Ana, CA (US); David Scott Whitefield, Andover, MA (US)

(21) Appl. No.: 18/941,220

(22) Filed: Nov. 8, 2024

Related U.S. Application Data
(60) Provisional application No. 63/597,146, filed on Nov. 8, 2023.

(51) Int. Cl. G06F 13/42

(52) U.S. Cl. CPC G06F 13/4282; G06F 2213/0012

(57) ABSTRACT

A system comprises a serial bus, a first module coupled to the serial bus, the first module being disposed on a first semiconductor die, including a first switch, and being configured to write to a first user identifier (USID), and a second module coupled to the serial bus, the second module being disposed on a second semiconductor die, including a second switch, and being configured to write to a second USID.

### CROSS-REFERENCE TO RELATED APPLICATION(S)

This application claims priority to U.S. Provisional Application No. 63/597,146, filed Nov. 8, 2023, the disclosure of which is hereby expressly incorporated by reference herein in its respective entirety.

### BACKGROUND

### Field

The present disclosure generally relates to radio-frequency (RF) architecture and interfacing.

### Description of the Related Art

End products (e.g., phones and/or other electronic devices) may have a group of components (e.g., RF front-end components) controlled by a single serial interface (e.g., MIPI). A baseband chipset provider can define the architecture of this set of RF front-end components and can program the serial MIPI control software to comply to only defined architecture.

### SUMMARY

In accordance with a number of implementations, the present disclosure relates to a system including a serial bus; a first module coupled to the serial bus, the first module being disposed on a first semiconductor die, including a first switch, and being configured to write to a first user identifier (USID); and a second module coupled to the serial bus, the second module being disposed on a second semiconductor die, including a second switch, and being configured to write to a second USID.

In some aspects, the techniques described herein relate to a system wherein the second module further includes a third switch and wherein the second module is further configured to write to the first USID and the second USID.

In some aspects, the techniques described herein relate to a system wherein the first module is further configured to readback the first USID.

In some aspects, the techniques described herein relate to a system wherein the second module is further configured to readback the second USID.

In some aspects, the techniques described herein relate to a system wherein the second module includes a diplexer coupled to the second switch and the third switch.

In some aspects, the techniques described herein relate to a system further including a first antenna coupled to the diplexer.

In some aspects, the techniques described herein relate to a system further including a second antenna coupled to the first switch.

In some aspects, the techniques described herein relate to a system wherein the first switch is a high-band switch, the second switch is a medium-band switch, and the third switch is a low-band switch.

In some aspects, the techniques described herein relate to a system further including a third module coupled to the serial bus, the third module being disposed on a third semiconductor die, including a third switch, and being configured to write to the first USID.

In some aspects, the techniques described herein relate to a system wherein the first module is configured to readback the first USID, the second module is configured to readback the second USID, and the third module is not configured to readback any USIDs.

In some aspects, the techniques described herein relate to a system wherein each of the first switch, the second switch, and the third switch is coupled to a separate antenna.

In accordance with a number of implementations, the present disclosure relates to a packaged module including: a serial bus; a first module coupled to the serial bus, the first module being disposed on a first semiconductor die, including a first switch, and being configured to write to a first user identifier (USID); and a second module coupled to the serial bus, the second module being disposed on a second semiconductor die, including a second switch, and being configured to write to a second USID.

In some aspects, the techniques described herein relate to a packaged module wherein the second module further includes a third switch and wherein the second module is further configured to write to the first USID and the second USID.

In some aspects, the techniques described herein relate to a packaged module wherein the second module includes a diplexer coupled to the second switch and the third switch.

In some aspects, the techniques described herein relate to a packaged module further including a third module coupled to the serial bus, the third module being disposed on a third semiconductor die, including a third switch, and being configured to write to the first USID.

In some aspects, the techniques described herein relate to a packaged module wherein the first module is configured to readback the first USID, the second module is configured to readback the second USID, and the third module is not configured to readback any USIDs.

In accordance with a number of implementations, the present disclosure relates to a wireless device including: a serial bus; a first module coupled to the serial bus, the first module being disposed on a first semiconductor die, including a first switch, and being configured to write to a first user identifier (USID); and a second module coupled to the serial bus, the second module being disposed on a second semiconductor die, including a second switch, and being configured to write to a second USID.

In some aspects, the techniques described herein relate to a wireless device wherein the second module further includes a third switch and wherein the second module is further configured to write to the first USID and the second USID.

In some aspects, the techniques described herein relate to a wireless device further including a third module coupled to the serial bus, the third module being disposed on a third semiconductor die, including a third switch, and being configured to write to the first USID.

In some aspects, the techniques described herein relate to a wireless device wherein the first module is configured to readback the first USID, the second module is configured to readback the second USID, and the third module is not configured to readback any USIDs.

For purposes of summarizing the disclosure, certain aspects, advantages, and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 illustrates a circuit configured to operate based on a Mobile Industry Processor Interface (MIPI) specification and/or in response to a MIPI bus (e.g., serial bus control), in accordance with one or more examples.

FIG. 2 illustrates an example reconfigurable serial interface addressing circuit in accordance with one or more examples.

FIG. 3 illustrates another example reconfigurable serial interface addressing circuit in accordance with one or more examples.

FIG. 4 illustrates an example system (e.g., circuit) configured to provide reconfiguration of serial interface addressing in accordance with one or more examples.

FIG. 5 provides a data table illustrating associations between USIDs and/or registers with the various modules of FIGS. 1-4.

FIG. 6 provides a data table showing how an example MIPI core may interact with the various circuits described herein.

FIG. 7 shows that in some embodiments, one or more features as described herein can be implemented in a packaged module.

FIG. 8 depicts an example wireless device having one or more advantageous features described herein.

### DESCRIPTION

The headings provided herein, if any, are for convenience only and do not necessarily affect the scope or meaning of the claimed invention.

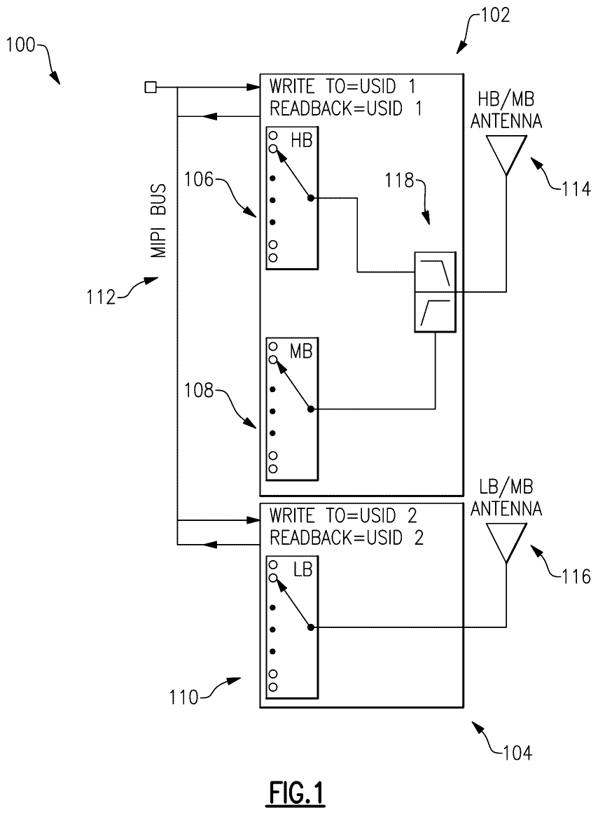

FIG. 1 illustrates a circuit 100 configured to operate based on a Mobile Industry Processor Interface (MIPI) specification and/or in response to a MIPI bus 112 (e.g., serial bus control), in accordance with one or more examples. The circuit 100 may be a radio-frequency (RF) front-end circuit comprising multiple components controlled by a MIPI bus 112. The MIPI bus 112 may comprise a serial interface bus. In some examples, a MIPI master specification may be programmed for a switch configuration of the circuit 100. For example, the circuit 100 may comprise a high-band/medium-band (HB/MB) module 102 and/or a low-band (LB) module 104. The HB/MB module 102 may comprise an HB switch 106 and/or an MB switch 108 coupled to a diplexer 118. The diplexer 118 may be configured to multiplex signals from the HB switch 106 and/or the MB switch 108 onto an HB/MB antenna 114. The LB module 104 may comprise an LB switch 110 coupled to an LB antenna 116.

The MIPI bus 112 can include a high-speed clock circuit path and/or one or more data circuit paths. Each circuit path may be carried on two wires (e.g., a write-to-lane and/or a readback lane). Circuit paths may travel from a MIPI host (e.g., master device) to one or more modules and/or switches (e.g., slave devices) the DSI device. When more than one circuit path is used, the circuit paths may be used in parallel to transmit data, with each sequential bit in the stream traveling on the next circuit path. That is, if two circuit paths are being used (e.g., one circuit path to the HB/MB module 102 and/or a second circuit path to the LB module 104), two bits may be transmitted simultaneously, one on each circuit path and/or each to a different USID. The link operates in either low power (e.g., LB) mode or high speed (e.g., HB/MB) mode. In low power mode, a high-speed clock may be disabled, and signal clocking information may be embedded in the data. In this mode, the data rate may be insufficient to drive a display, but may be usable for sending configuration information and/or commands. High speed mode enables the high-speed clock (at frequencies from tens of megahertz to over one gigahertz) that acts as the bit clock for the data lanes. Clock speeds vary by the requirements of the display. High speed mode is still designed to reduce power usage due to its low voltage signaling and parallel transfer ability.

The bus 112 may be configured to control one or more slave devices (e.g., switches). Each slave device can be responsive to and/or associated with one or more slave addresses. A slave address can include a user identifier (USID). In some examples, a slave address can comprise a four-bit (or more) string of values defining a stored location of a data object (e.g., register address and/or string).

Signals may be transmitted to the HB/MB module 102 and the LB module 104 via a MIPI bus 112 that may be coupled to the HB switch 106, MB switch 108, and/or LB switch 110. The HB/MB module 102 may be configured to write to a first USID (e.g., USID 1) and/or to readback the first USID. The LB module 104 may be configured to write to and/or readback a second USID (e.g., USID 2). The HB/MB module 102 and/or the LB module 104 may each be configured to be responsive to only a single USID.

The architecture of the circuit 100 may be determined and/or defined by a baseband chipset provider. In some cases, a provider may program control software (e.g., serial MIPI control software) to comply to only a specific defined architecture. Various end customers (e.g., original equipment manufacturers (OEMs)) of the circuit 100 may be unable to change the architecture of the circuit 100 and/or may be locked into the chipset's fixed serial-interface software definition.

Some example circuits, devices, and/or systems herein may be configured to allow end customers to utilize a fixed serial-interface software definition while also allowing such users to change the RF architecture. For example, devices described herein can contain a reconfigurable serial interface addressing method.

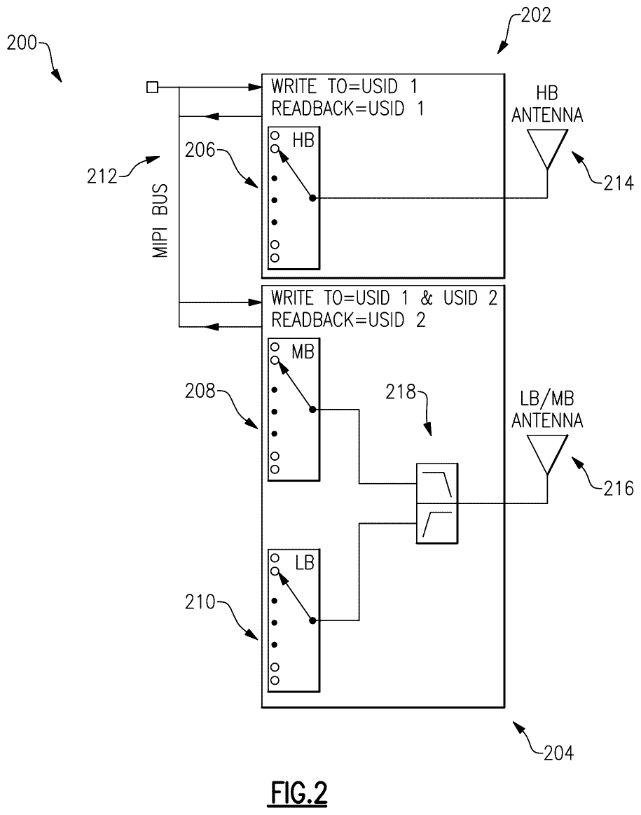

FIG. 2 illustrates an example reconfigurable serial interface addressing circuit 200 in accordance with one or more examples. The circuit 200 may be an RF front-end circuit comprising multiple components controlled by a MIPI bus 212. The MIPI bus 212 may comprise a serial interface bus. In some examples, a MIPI master specification may be programmed for a switch configuration of the circuit 200. For example, the circuit 200 may comprise an HB module 202 and/or an LB/MB module 204. The HB module 202 may comprise an HB switch 206 coupled to an HB antenna 214. The LB/MB module 204 may comprise an LB switch 210 and/or an MB switch 208 coupled to a diplexer 218. The diplexer 218 may be configured to multiplex signals from the LB switch 210 and/or the MB switch 208 onto an LB/MB antenna 216.

Signals may be transmitted to the HB module 202 and/or the LB/MB module 204 via a MIPI bus 212 that may be coupled to the HB switch 206, MB switch 208, and/or LB switch 210. The HB module 202 may be configured to write to USID 1 and/or to readback USID 1. The LB/MB module 204 may be configured to write to USID 1 and/or USID 2 and/or may be configured to readback USID 2. The HB module 202 may be configured to be responsive to only a single USID (e.g., USID 1) and/or the LB/MB module 204 may be configured to be responsive to multiple USIDs (e.g., USID 1 and/or USID 2).

The circuit 200 may be configured for use with multiple different architecture configurations without changing the serial-interface software of the circuit 200. In some examples, the circuit 200 may be applied with a known and/or fixed serial-interface software functionality to selectively respond to only serial-interface commands that apply to the architecture of each particular architecture configuration. The circuit 200 may be configured to selectively respond to read-back commands as if such commands were arranged in the architecture defined by the chipset manufacturer. Accordingly, the circuit 100 may provide flexibility for different architectures within RF front-end products.

The MIPI bus 212 and/or MIPI master may be configured to control the HB switch 206, MB switch 208, and/or LB switch 210 using common and/or identical controls as with the circuit 100 of FIG. 1. The LB/MB module 204 (e.g., dual switch) may be configured to accept commands from multiple USIDs (e.g., USID 1 and USID 2) and/or may be configured to only respond to a single USID (e.g., USID 2).

The LB/MB module 204 and/or the circuit 200 in general may be configured to operate using configurable slave addresses having different USIDs with one or more pins. In some examples, multiple slave devices (e.g., the HB switch 206, MB switch 208, and/or LB switch 210) may be configured to be reused with different USIDs accessed by the MIPI bus 212.

The HB switch 206, MB switch 208, and/or LB switch 210 may each comprise a MIPI core and/or may be configured to be accessible via multiple different orientations of mode pins. The circuit 200 may comprise one or more mode pins configured to determine which pins may be accessed by the MIPI cores of the various switches.

In some examples, the HB module 202 and the LB/MB module 204 may be disposed on separate semiconductor dies. Each semiconductor die may comprise one or more mode pins internal to the semiconductor die and configured to decode USIDs. Because the LB/MB module 204 can write to both USID 1 and USID 2, the LB/MB module 204 may be configured to be accessed by both USID 1 and USID 2. That is, the MB switch 208 may be configured to respond to USID 1 (similar to the HB switch 206) while being disposed on a separate semiconductor die from the HB switch 206.

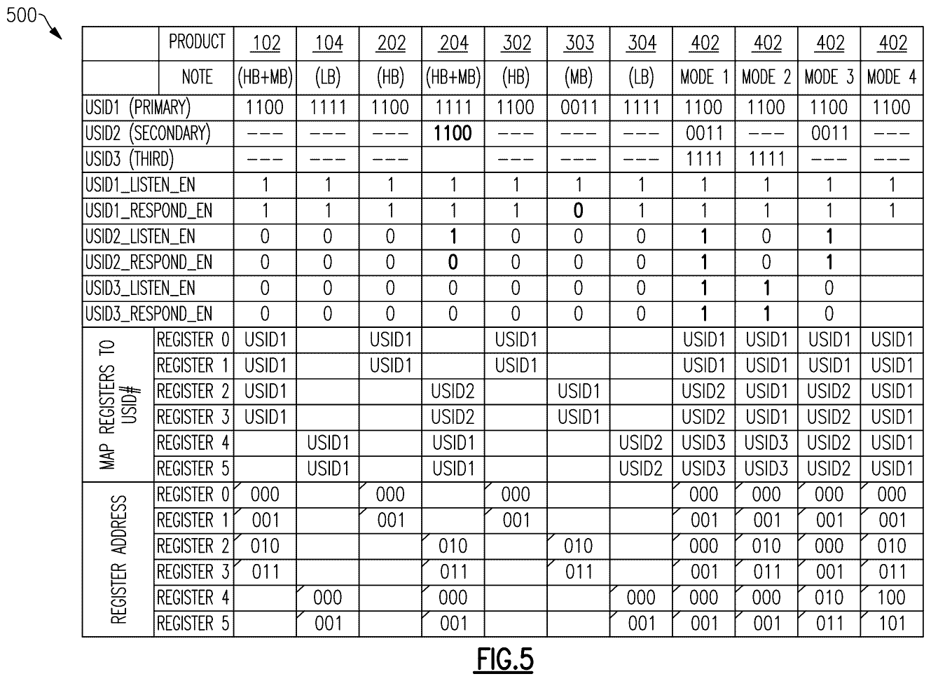

One or more registers may be used to control the HB switch 206, MB switch 208, and/or LB switch 210. Some registers may be configured to be accessed by multiple USIDs. Certain registers may be used to control certain switches (see, e.g., FIG. 5).

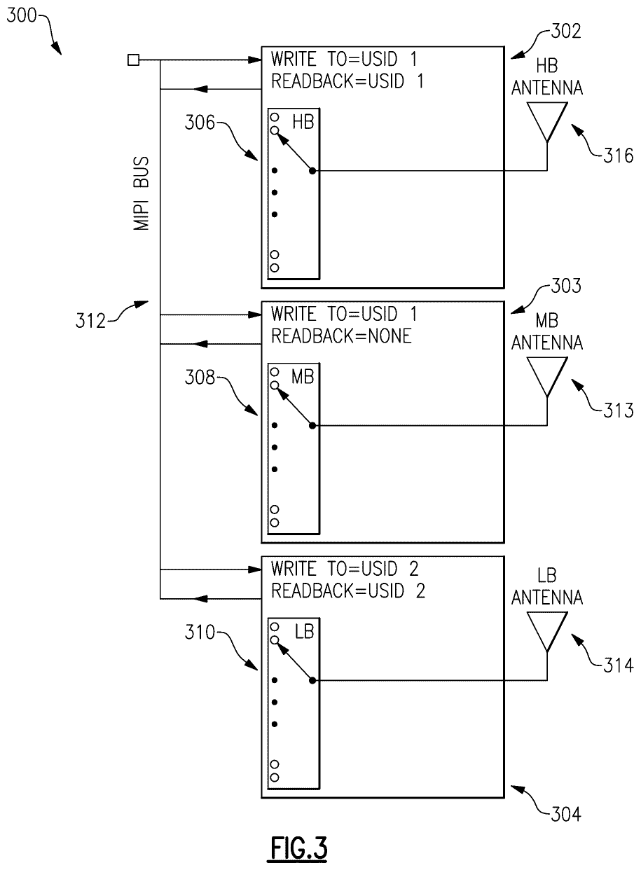

FIG. 3 illustrates another example reconfigurable serial interface addressing circuit 300 in accordance with one or more examples. The circuit 300 may be an RF front-end circuit comprising multiple components controlled by a MIPI bus 312. The MIPI bus 312 may comprise a serial interface bus. In some examples, a MIPI master specification may be programmed for a switch configuration of the circuit 300. For example, the circuit 300 may comprise an HB module 302, an MB module 303, and/or an LB module 304. The HB module 302 may comprise an HB switch 306 coupled to an HB antenna 316. The MB module 303 may comprise an MB switch 308 coupled to an MB antenna 313. The LB module 304 may comprise an LB switch 310 coupled to an LB antenna 314.

Signals may be transmitted to the HB module 302, the MB module 303, and/or the LB module 304 via a MIPI bus 312 that may be coupled to the HB switch 306, MB switch 308, and/or LB switch 310. The HB module 302 may be configured to write to USID 1 and/or to readback USID 1. The MB module 303 may be configured to write to USID 1 and/or may not be configured to readback to any USIDs. The LB module 304 may be configured to write to USID 2 and/or may be configured to readback USID 2. Each of the HB module 302, MB module 303, and/or LB module 304 may be configured to be responsive to only a single USID (e.g., USID 1 or USID 2).

The MIPI bus 312 and/or MIPI master configuration may be configured to controls switches with a common and/or identical control configuration as with the circuit 100 of FIG. 1. The MB module 303 may be configured to accept commands from one or more USIDs (e.g., USID 1) without sending a readback command.

Each of the HB module 302, the MB module 303, and the LB module 304 and/or each of the HB switch 306, MB switch 308, and LB switch 310 may be disposed within separate semiconductor dies. In some examples, different technologies (e.g., different USIDs and/or registers) may be used for each module and/or switch.

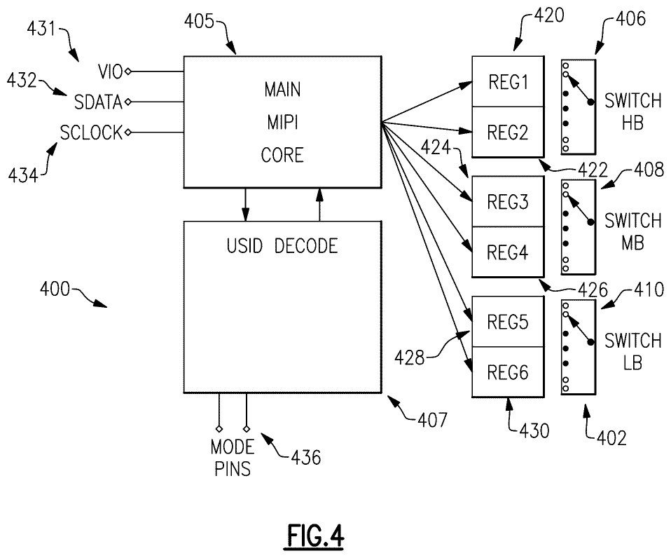

FIG. 4 illustrates an example system 400 (e.g., circuit) configured to provide reconfiguration of serial interface addressing in accordance with one or more examples. The system 400 comprises a main MIPI core 405 configured to transmit data (e.g., USIDs) to an HB switch 406, an MB switch 408, and/or an LB switch 410 of a module 402. The main MIPI core 405 may be coupled to a USID decode module 407 comprising one or more mode pins 436 configured to decode one or more USIDs.

The main MIPI core 405 may comprise an input offset voltage (VIO) 431, a serial data line (SDATA) 432, and/or a serial clock line (SCLOCK) 434. The core 405 may be configured to transmit one or more USIDs to various registers associated with the switches. For example, the system 400 may comprise a first register 420, a second register 422, a third register 424, a fourth register 426, a fifth register 428, and/or a sixth register 430. The registers may be configured to control the HB switch 406, MB switch 408, and/or LB switch 410.

The mode pins 436 can be hard coded and/or can be part of a product pin. The mode pins 436 may be configured to define different cases (e.g., how each of the switches responds to commands) and/or which commands each switch is responsive to.

FIG. 5 provides a data table 500 illustrating associations between USIDs and/or registers with the various modules of FIGS. 1-4.

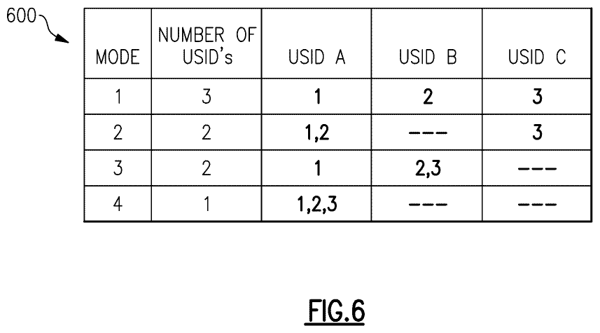

FIG. 6 provides a data table 600 showing how an example MIPI core may interact with the various circuits described herein. For example, mode 1 may correspond to the circuit 300 of FIG. 3, in which each of three switches is disposed on a separate semiconductor die. Mode 3 may correspond to the circuit 200 of FIG. 2, in which an HB module 202 is responsive to a single USID and/or an LB/MB module 204 is responsive to multiple USIDs.

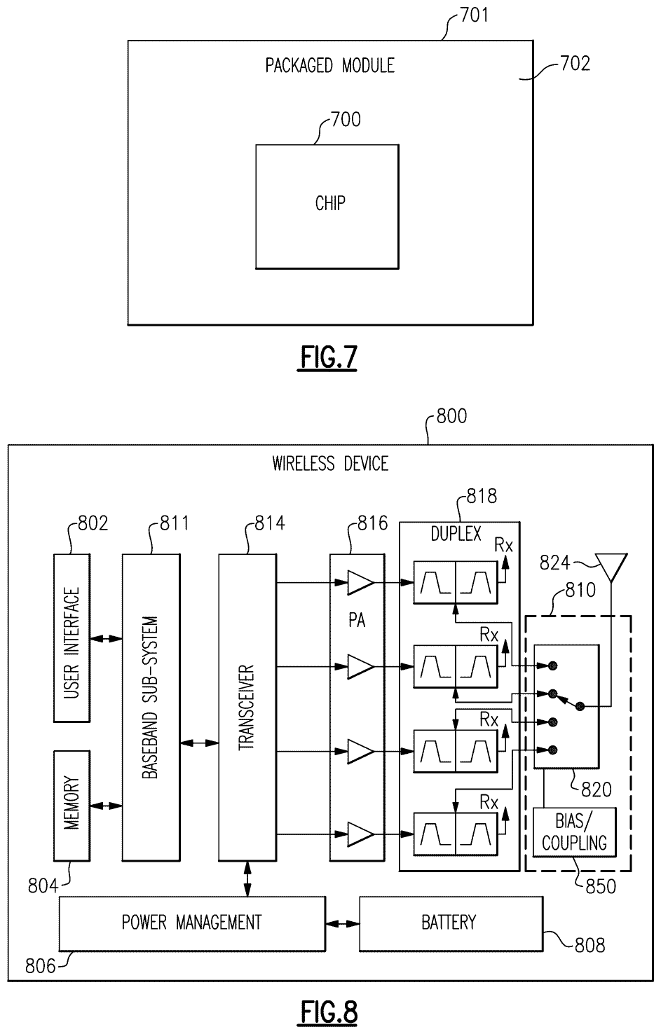

FIG. 7 shows that in some embodiments, one or more features as described herein can be implemented in a packaged module 701. Such a packaged module can include a packaging substrate 702 configured to receive a plurality of components. At least some of the components mounted on the packaging substrate 702 can include a flip chip device 700 such as one or more of the example flip chip devices described herein.

In some implementations, a device and/or a circuit having one or more features described herein can be included in an RF device such as a wireless device. Such a device and/or a circuit can be implemented directly in the wireless device, in a modular form as described herein, or in some combination thereof. In some embodiments, such a wireless device can include, for example, a cellular phone, a smart-phone, a hand-held wireless device with or without phone functionality, a wireless tablet, etc.

FIG. 8 depicts an example wireless device 800 having one or more advantageous features described herein. In some embodiments, a switching module 820 of a switching circuit 810 can include one or more RDL inductance as described herein.

In the example wireless device 800, a power amplifier (PA) assembly 816 having a plurality of PAs can provide one or more amplified RF signals to the switch 820 (via an assembly of one or more duplexers 818), and the switch 820 can route the amplified RF signal(s) to one or more antennas. The PAs 816 can receive corresponding unamplified RF signal(s) from a transceiver 814 that can be configured and operated in known manners. The transceiver 814 can also be configured to process received signals. The transceiver 814 is shown to interact with a baseband sub-system 811 that is configured to provide conversion between data and/or voice signals suitable for a user and RF signals suitable for the transceiver 814. The transceiver 814 is also shown to be connected to a power management component 806 that is configured to manage power for the operation of the wireless device 800 and/or that may be coupled to a battery 808. Such a power management component can also control operations of the baseband sub-system 811 and the module 820. The sub-system 811 may comprise a bias/coupling module 850.

The baseband sub-system 811 is shown to be connected to a user interface 802 to facilitate various input and output of voice and/or data provided to and received from the user. The baseband sub-system 811 can also be connected to a memory 804 that is configured to store data and/or instructions to facilitate the operation of the wireless device, and/or to provide storage of information for the user.

In some embodiments, the duplexers 818 can allow transmit and receive operations to be performed simultaneously using a common antenna (e.g., 824). In FIG. 8, received signals are shown to be routed to “Rx” paths that can include, for example, one or more low-noise amplifiers (LNAs).

A number of other wireless device configurations can utilize one or more features described herein. For example, a wireless device does not need to be a multi-band device. In another example, a wireless device can include additional antennas such as diversity antenna, and additional connectivity features such as Wi-Fi, Bluetooth, and GPS.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled,” as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Description using the singular or plural number may also include the plural or singular number, respectively. The word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While some embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions, and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A system comprising:
a serial bus;
a first module coupled to the serial bus, the first module being disposed on a first semiconductor die, including a first switch, and being configured to write to a first user identifier (USID); and
a second module coupled to the serial bus, the second module being disposed on a second semiconductor die, including a second switch, and being configured to write to a second USID.

2. The system of claim 1 wherein the second module further comprises a third switch and wherein the second module is further configured to write to the first USID and the second USID.

3. The system of claim 2 wherein the first module is further configured to readback the first USID.

4. The system of claim 3 wherein the second module is further configured to readback the second USID.

5. The system of claim 2 wherein the second module comprises a diplexer coupled to the second switch and the third switch.

6. The system of claim 5 further comprising a first antenna coupled to the diplexer.

7. The system of claim 6 further comprising a second antenna coupled to the first switch.

8. The system of claim 2 wherein the first switch is a high-band switch, the second switch is a medium-band switch, and the third switch is a low-band switch.

9. The system of claim 1 further comprising a third module coupled to the serial bus, the third module being disposed on a third semiconductor die, including a third switch, and being configured to write to the first USID.

10. The system of claim 9 wherein the first module is configured to readback the first USID, the second module is configured to readback the second USID, and the third module is not configured to readback any USIDs.

11. The system of claim 9 wherein each of the first switch, the second switch, and the third switch is coupled to a separate antenna.

12. A packaged module comprising:
a serial bus;
a first module coupled to the serial bus, the first module being disposed on a first semiconductor die, including a first switch, and being configured to write to a first user identifier (USID); and
a second module coupled to the serial bus, the second module being disposed on a second semiconductor die, including a second switch, and being configured to write to a second USID.

13. The packaged module of claim 12 wherein the second module further comprises a third switch and wherein the second module is further configured to write to the first USID and the second USID.

14. The packaged module of claim 13 wherein the second module comprises a diplexer coupled to the second switch and the third switch.

15. The packaged module of claim 12 further comprising a third module coupled to the serial bus, the third module being disposed on a third semiconductor die, including a third switch, and being configured to write to the first USID.

16. The packaged module of claim 15 wherein the first module is configured to readback the first USID, the second module is configured to readback the second USID, and the third module is not configured to readback any USIDs.

17. A wireless device comprising:
a serial bus;
a first module coupled to the serial bus, the first module being disposed on a first semiconductor die, including a first switch, and being configured to write to a first user identifier (USID); and
a second module coupled to the serial bus, the second module being disposed on a second semiconductor die, including a second switch, and being configured to write to a second USID.

18. The wireless device of claim 17 wherein the second module further comprises a third switch and wherein the second module is further configured to write to the first USID and the second USID.

19. The wireless device of claim 17 further comprising a third module coupled to the serial bus, the third module being disposed on a third semiconductor die, including a third switch, and being configured to write to the first USID.

20. The wireless device of claim 19 wherein the first module is configured to readback the first USID, the second module is configured to readback the second USID, and the third module is not configured to readback any USIDs.
